(19) United States
(12) Patent Application Publication
(10) Pub. No.: US 2001/0055354 A1
(43) Pub. Date: Dec. 27, 2001

(54) Method & apparatus for data rate synchronization

(76) Inventors: Danny Fung, Walnut, CA (US); Mohammad Usman, Mission Viejo, CA (US); Sherjil Ahmed, Irvine, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/798,536

(22) Filed: Mar. 2, 2001

Related U.S. Application Data
(60) Provisional application No. 60/186,733, filed on Mar. 3, 2000.
(60) Provisional application No. 60/195,015, filed on Apr. 6, 2000.

(51) Int. Cl. H04L 7/00

(52) U.S. Cl. 375/354

(57) ABSTRACT

A communication system adjusts data rate to compensate for frequency variations in conversion clocks. The communication system includes a conversion clock at a transmitter and a conversion clock at a receiver that advance respective counters. A difference between the counters controls a resampling of digital data sent from the transmitter to the receiver. The conversion clocks run independently of each other. The difference between the counters incremented by respective conversion clocks provides an indication of the difference in frequencies between the conversion clocks. The difference is used to determine the ratio at which digitized information is resampled at the receiver before being converted to the analog domain.

### RELATED APPLICATIONS

The present application claims priority to co-pending provisional application entitled METHOD AND APPARATUS FOR DATA RATE SYNCHRONIZATION, application Ser. No. 60/186,733, filed Mar. 3, 2000, and to co-pending provisional application entitled SYNCHRONIZATION FOR DIGITAL CABLE NETWORK, application Ser. No. 60/195,015, filed Apr. 6, 2000, which are hereby incorporated by reference in their entirety.

### BACKGROUND OF THE INVENTION

1. Field of the Invention

This invention relates generally to digital signal processing, and more specifically to synchronization of data rates between a transmitter and a receiver.

2. Description of the Related Art

Digital techniques are employed to reliably and securely communicate information. Real-life information (e.g., speech, music, video, etc.) is produced and perceived as analog signals (i.e., time-continuous signals). The real-life information is sampled and digitized at a transmitter, and the digitized information is converted back to the analog signals at a receiver of a digital communication system.

An Analog-to-Digital Converter (ADC) samples and digitizes analog signals, and a Digital-to-Analog Converter (DAC) converts digitized signals to analog signals. To avoid distortion, the rate at which information is digitized (i.e., data generation rate) is synchronous with the rate at which the digitized information is converted to analog signals (i.e., data consumption rate). A difference between the data generation rate and the data consumption rate results in a spectral expansion or a spectral compression of the information at the receiver. A difference between the data generation rate and the data consumption rate also typically results in a shortage or an excess of digital samples to be present at the DAC input which causes the DAC buffer to under-run or over-run.

The ADC and the DAC operations are controlled by respective conversion clocks. One method for synchronizing the data generation rate and the data consumption rate is to synchronize the conversion clocks (i.e., lock the frequencies of the ADC conversion clock and the DAC conversion clock). An off-the-shelf crystal oscillator for generation of the conversion clock is typically accurate to within ±100 parts-per-million (ppm) of its stated frequency. If the ADC and the DAC each use similar crystal oscillators, the worst case disparity between their respective conversion clock frequencies is ±200 ppm in this particular case. Although the difference between the conversion clock frequencies appears to be slight, the relative time represented by each clock eventually causes an excess or shortage of samples to be present at the DAC input.

### SUMMARY OF THE INVENTION

The present invention solves these and other problems by providing a communication system wherein a data rate is adjusted to compensate for frequency variations in a conversion clock. The communication system includes a conversion clock at a transmitter and a conversion clock at a receiver that advance respective counters. A difference between the counters controls a resampling of digital data sent from the transmitter to the receiver. The conversion clocks run independently of each other. The difference between the counters incremented by respective conversion clocks provides an indication of the difference in frequencies between the conversion clocks. The difference is used to determine the ratio at which digitized information is resampled at the receiver before being converted to the analog domain. Proper resampling (i.e., data rate adjustment) avoids a shortage or an excess of digital samples at a DAC input when the frequencies of the respective conversion clocks differ.

The receiver determines a resampling ratio based on a difference between an ADC conversion clock frequency and a DAC conversion clock frequency. In one embodiment, the transmitter and the receiver include respective counters. The transmitter counter is incremented by the ADC conversion clock (or some multiple thereof) and the receiver counter is incremented by the DAC conversion clock (or some multiple thereof). The counters count cumulatively and wrap when a maximum number is reached. The receiver receives an indication of the ADC conversion clock frequency from a cumulative count incremented by the ADC conversion clock. Cumulative counts are sent to the receiver intermittently or periodically with data. The receiver extracts the ADC cumulative counts from the received data.

In one embodiment, the receiver compares a current ADC cumulative count with a previous ADC cumulative count stored in memory. The receiver similarly compares a current DAC cumulative count with a previous DAC cumulative count stored in memory. When the ADC conversion clock is synchronous with the DAC conversion clock, the rates of change in their respective cumulative counts are the same. When the ADC conversion clock frequency and the DAC conversion clock frequency are different from each other, the rates of change in their respective cumulative counts drift apart. The amount of drift between the rates of change corresponds to the amount of difference between the ADC and the DAC conversion clock frequencies.

In an alternate embodiment, the receiver compares the current ADC cumulative count with the current DAC cumulative count. When the ADC conversion clock is synchronous with the DAC conversion clock, the difference is zero or a fixed amount each time. When the ADC conversion clock and the DAC conversion clock frequencies are different from each other, the difference between the cumulative counts varies. The variation of the difference between the cumulative counts provides the receiver with an indication of the difference between the ADC conversion clock frequency and the DAC conversion clock frequency.

Resampling compensates for the disparity between the ADC conversion clock frequency and the DAC conversion clock frequency. Resampling involves decimation and/or interpolation of data. A resampler takes input data at one rate and generates output data at another rate. A control word or a control signal is provided to the resampler to control the ratio of the input data rate to the output data rate. In one embodiment, the control word is derived from the difference between the rate of change in the ADC cumulative count and the rate of change in the DAC cumulative count. In an alternate embodiment, the control word is derived from the variation of differences between the current ADC cumulative counts and the current DAC cumulative counts.

In one embodiment, data rate synchronization is employed in a cable television distribution system. Analog video channels are sampled digitally at a transmitter for transmission through a communication channel. The digitized samples are converted back to the analog format at a receiver. Analog video channels have bandwidths of approximately 6 Mega-Hertz (MHz) each. In one embodiment, each analog video channel is digitized by a respective ADC. The conversion clocks of respective ADCs function independently of each other. Accordingly, each conversion clock increments a respective counter.

In preparation for transmission, the digitized data for each analog video channel is framed (i.e., arranged in a specified order) and combined with other digital information (e.g., other digitized analog video channels and digital video channels) using Time Division Multiplexing (TDM). During the framing process, the cumulative counts of respective counters are added to the respective frames for transmission to the receiver. Fiber optic cables or coaxial cables can be used for the transmission.

The receiver demultiplexes the incoming TDM signal back into the individual frames. The cumulative counts are extracted from the respective frames during the deframing process when digitized channels are recovered. The cumulative counts are provided to respective control circuits while the digitized channels are provided to respective resamplers. The resampled data at the outputs of respective resamplers are combined by a bank of modulators using frequency division multiplexing. The combined digital signal is converted to an analog signal using a DAC. The analog signal can be further processed and transmitted to subscribers.

The DAC is controlled by a conversion clock. The DAC conversion clock (or some multiple thereof) increments a counter. The value of the counter is provided to the control circuits which output appropriate control words or control signals to the respective resamplers using methods discussed above.

In one embodiment, a common conversion clock controls the operations of ADCs in a transmitter. The common conversion clock also controls a transmitter synchronization circuit. The output of the transmitter synchronization circuit (i.e., transmitter time stamp) is provided to a multiplexer for combination with data signals into one transport stream which is transmitted to a receiver.

The receiver includes a demultiplexer that separates the incoming transport stream into individual data streams and extracts the transmitter time stamp. The transmitter time stamp is provided to a receiver synchronization circuit which also receives a receiver time stamp derived from a receiver conversion clock. The receiver synchronization circuit provides an appropriate control signal to resample the individual data streams to compensate for a frequency difference between the common conversion clock in the transmitter and the receiver conversion clock.

### BRIEF DESCRIPTION OF THE DRAWINGS

FIG. 1 is an illustration of a communication system.

FIG. 2 is a block diagram of one embodiment of a transmitter conversion circuit shown in FIG. 1.

FIG. 3 is a block diagram of one embodiment of a receiver conversion circuit shown in FIG. 1.

FIG. 4 is an illustration of a cable television distribution system.

FIG. 5 is a block diagram of one embodiment of a transmitter shown in FIG. 4.

FIG. 6 is a block diagram of one embodiment of a receiver shown in FIG. 4.

FIG. 7 is a block diagram of an alternate embodiment of a transmitter shown in FIG. 4.

FIG. 8 is a block diagram of an alternate embodiment of a receiver shown in FIG. 4.

In the figures, the first digit of any three-digit number generally indicates the number of the figure in which the element first appears.

### DETAILED DESCRIPTION OF THE INVENTION

The present invention involves data rate synchronization or equalization in a digital communication system wherein digital data is sent from an ADC to a DAC which operate at different clock rates. The ADC clock rate determines a data generation rate (i.e., the rate at which digital data is generated). The DAC clock rate determines a data consumption rate (i.e., the rate at which digital data is converted to an analog signal). The digital data is resampled to compensate for a difference between the data generation rate and the data consumption rate in the digital communication system.

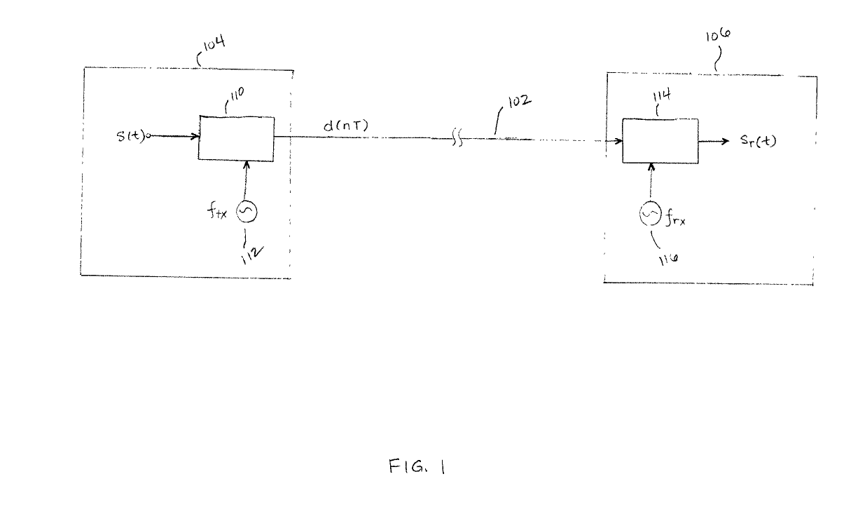

A digital communication system is illustrated in FIG. 1. The digital communication system includes a transmitter 104 and a receiver 106. Information in the analog domain (e.g., time-continuous signals such as speech, music, video, telemetry data, etc.) are sampled and digitized in the transmitter 104 for reliable and secured transmission to the receiver 106. The receiver 106 can convert the digitized information back to the analog domain.

In the transmitter 104, an analog input signal s(t) is provided to a transmitter conversion circuit 110 for conversion to digital bits. A transmitter conversion clock 112, with an operating frequency fₜₓ, is provided to the transmitter conversion circuit 110 to control the rate at which the digital bits are generated (i.e., data generation rate). The digital output d(nT) of the transmitter conversion circuit 100 is provided to a receiver conversion circuit 114 in the receiver 106 via a communication channel 102. The communication channel 102 can be a cable, optical, wireless link, etc.

The receiver conversion circuit 114 converts the digital bits back into a recovered analog signal sᵣ(t). A receiver conversion clock 116, with an operating frequency fᵣₓ, is provided to the receiver conversion circuit 114 to control the rate at which the digital bits are converted back to the analog domain (i.e., data consumption rate).

In one embodiment, the transmitter conversion clock 112 and the receiver conversion clock 116 run independently of each other. If there is a difference in the respective operating frequencies of the transmitter conversion clock 112 and the receiver conversion clock 116, the data generation rate will be different from the data consumption rate. The difference between the data generation rate and the data consumption rate results in a spectral expansion or compression of the digitized information at the receiver 106 (i.e., distortion in the recovered analog signal sᵣ(t)). The present invention solves this and other problems by sensing the difference between the respective operating frequency of the transmitter conversion clock 112 and the operating frequency of the receiver conversion clock 116 and resampling the digitized data accordingly before conversion back to the analog domain.

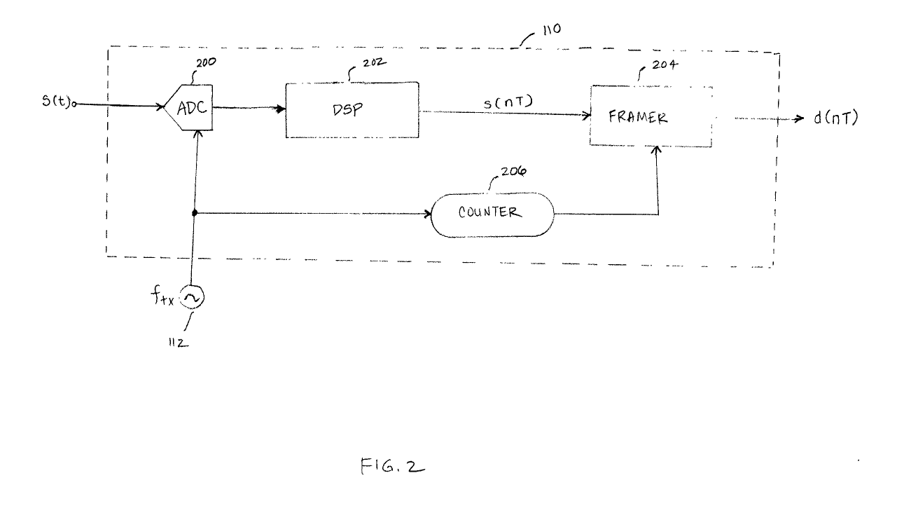

FIG. 2 is a block diagram of one embodiment of the transmitter conversion circuit 110 which sends an indication of the operating frequency of the transmitter conversion clock 112 to the receiver 106. The analog input signal s(t) is provided to the input of an ADC 200 for conversion into digital bits. The output of the ADC 200 is provided to a Digital Signal Processor (DSP) 202 for further processing, such as digital filtering and the like. The DSP 202 provides a digital signal s(nT) to a framer 204.

The ADC 200 samples and digitizes the analog input signal s(t) at a data generation rate controlled by the transmitter conversion clock 112 (i.e., the ADC clock). The transmitter conversion clock 112 is also provided to a transmitter counter 206. The output of the transmitter counter 206 is provided to the framer 204. The framer 204 outputs a digital signal d(nT) for transmission to the receiver 106 through the communication channel 102.

In one embodiment, the transmitter counter 206 is incremented by the ADC clock 112 (or some multiple thereof), and the changing value of the transmitter counter 206 is used to detect the frequency of the ADC clock 112. In one embodiment, the transmitter counter 206 counts cumulatively and wraps when a maximum number is reached. The maximum number is determined by the number of bits in the transmitter counter 206 and can be varied depending upon the desired resolution in frequency detection. The transmitter cumulative counts (i.e., the transmitter count stamps) are provided to the framer 204 to be sent to the receiver 106 intermittently or periodically with data.

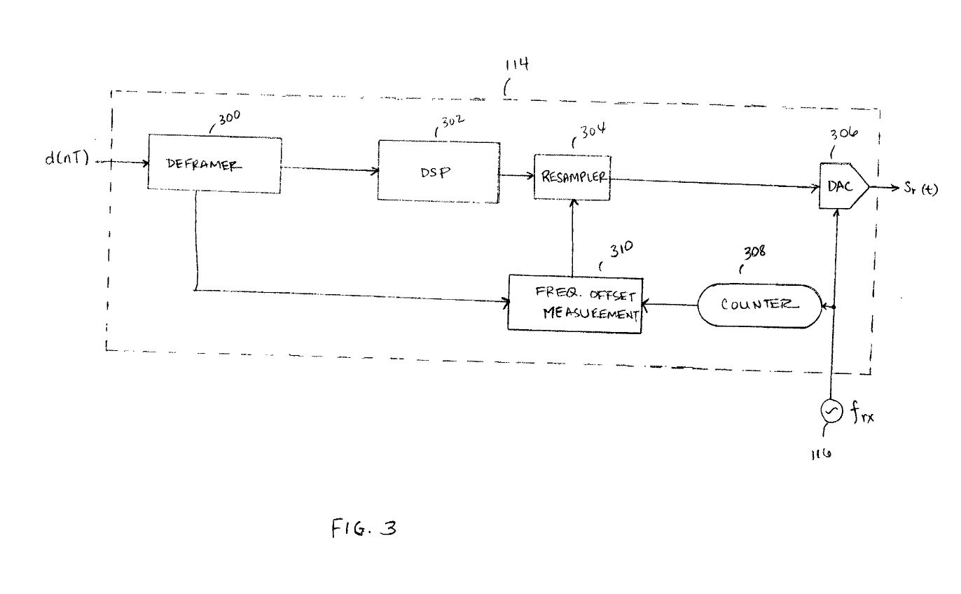

FIG. 3 is a block diagram of one embodiment of the receiver conversion circuit 114 which resamples digital data to compensate for a difference between the respective operating frequencies of the ADC clock 112 and the receiver conversion clock 116. In one embodiment, the digital signal d(nT), including the digital data and the frequency indication of the ADC clock 112, is received from the transmitter 104 and provided to a deframer 300. The deframer 300 separates the transmitter cumulative count from the data and sends the transmitter cumulative count to a frequency offset measurement circuit 310 (i.e., control circuit) while sending the data to a DSP 302. The output of the DSP 302 is provided to a resampler 304. The output of the resampler 304 is provided to a DAC 306 which outputs the recovered analog signal sᵣ(t).

The DAC 306 converts digitized information back into the analog domain at a rate controlled by the receiver conversion clock 116 (i.e., the DAC clock). The DAC clock 116 is also provided to a receiver counter 308. In one embodiment, the receiver counter 308 is incremented by the DAC clock 116 (or some multiple thereof), and the changing value of the receiver counter 308 can be used to detect the frequency of the DAC clock 116. The receiver counter 308 counts cumulatively and wraps when a maximum number is reached. The maximum number is determined by the number of bits in the receiver counter 308 and can be varied depending upon the desired resolution in frequency detection. The receiver cumulative counts (i.e., receiver count stamps) are provided to the frequency offset measurement circuit 310. The output of the frequency offset measurement circuit 310 controls the resampler 304.

In one embodiment, resampling compensates for a disparity between the ADC clock 112 and the DAC clock 116. The resampler 304 receives input data from the DSP 302 at one rate and generates output data to the DAC 306 at another rate. The frequency offset measurement circuit 310 provides a control word, a control signal, or a control count to control the ratio of the input data rate to the output data rate of the resampler 304.

Resampling involves decimation and/or interpolation of data. For example, if the ADC clock 112 runs faster than the DAC clock 116, the resampler 304 decimates the input data. Similarly, if the ADC clock 112 runs slower than the DAC clock 116, the resampler 304 interpolates the input data. Proper resampling (i.e., data rate adjustment) avoids a shortage or an excess of digital samples at the input of the DAC 306 when the frequencies of the ADC clock 112 and the DAC clock 116 differ.

In one embodiment, the frequency offset measurement circuit 310 outputs a control word to the resampler 304 based on a difference between the transmitter count stamp and the receiver count stamp. The difference between the count stamps provides an indication of the difference in frequency between the ADC clock 112 and the DAC clock 116.

For example, the frequency offset measurement circuit 310 compares a current transmitter count stamp with a current receiver count stamp. When the ADC clock 112 is synchronous with the DAC clock 116, the difference between the current count stamps is zero or a fixed amount each time. Channel delay (i.e., amount of time it takes for data to travel from the transmitter 104 to the receiver 106) is assumed to be relatively consistent over time. Alternatively, the channel delay is relatively insignificant in comparison to long term observations of differences in count stamps.

When the respective frequencies of the ADC clock 112 and the DAC clock 116 are different from each other, the differences between the count stamps vary over time. The variation of the differences between the count stamps provides indications of the frequency differences between the ADC clock 112 and the DAC clock 116 over time. The integral error (i.e., cumulative long-term effect) of slight frequency differences becomes significant over time. Therefore, the count stamps can provide very accurate indications of frequency differences after a sufficient amount of time.

In another embodiment, the frequency offset measurement circuit 310 compares a current transmitter count stamp with a previous transmitter count stamp stored in memory. The frequency offset measurement circuit 310 similarly compares a current receiver count stamp with a previous receiver count stamp stored in memory.

When the ADC clock 112 is synchronous with the DAC clock 116, the rates of change in the respective count stamps are the same. When the ADC clock 112 and the DAC clock 116 differ from each other, the rates of change in the respective count stamps drift apart. The amount of drift between the rates of change corresponds to the amount of frequency difference between the ADC clock 112 and the DAC clock 116. Accordingly, the frequency offset measurement circuit 310 derives a control word for the resampler 304 based on the difference between the rate of change in the transmitter count stamp and the rate of change in the receiver count stamp.

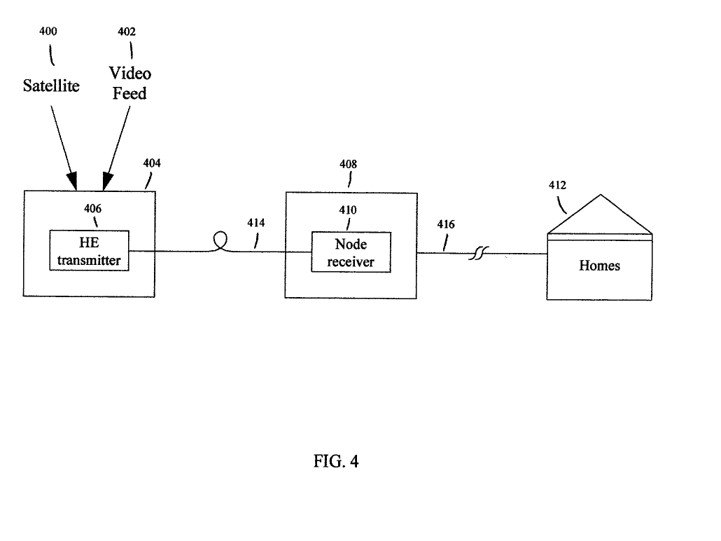

The data rate equalization techniques described above can be applied in a cable television distribution system as illustrated in FIG. 4. Data from various sources, such as signals received from a satellite 400 or signals from a video feed 402, are received at a headend 404. The headend 404 prepares the received information for transmission to at least one node 408, which then passes the information to homes 412 (i.e., subscribers). Fiber optic cables 414 are typically used in transmission paths between the headend 404 and the node 408, while coaxial cables 416 are typically used in transmission paths between the node 408 and the homes 412.

In one embodiment, a transmitter 406 in the headend 404 samples and digitizes analog video channels for transmission to a receiver 410 in the node 408. The receiver 410 converts the digitized video channels back to the analog domain before broadcasting the video channels to the homes 412.

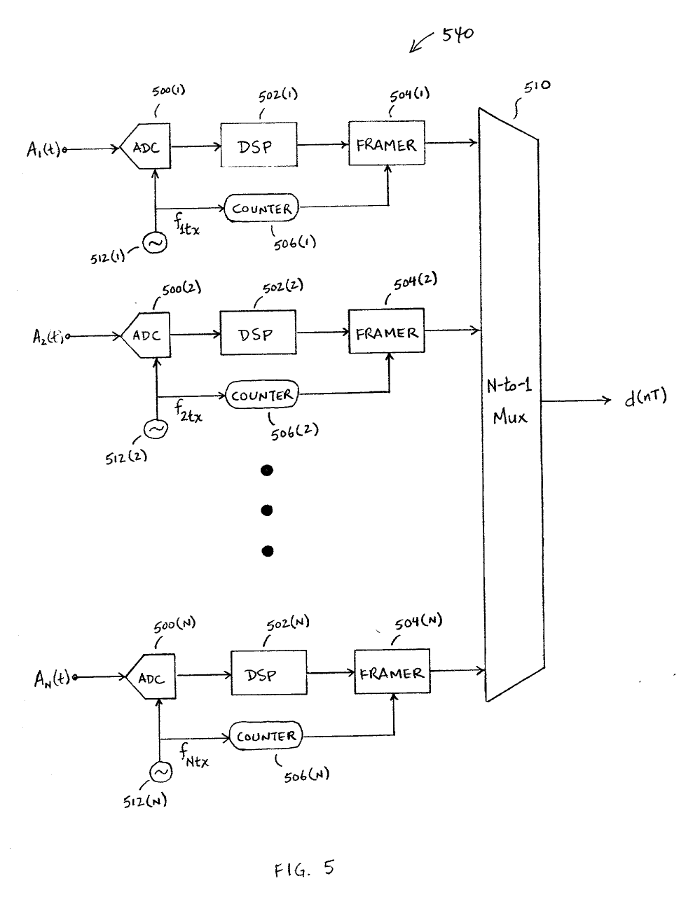

FIG. 5 is a block diagram of a transmitter 540, which is one embodiment of the transmitter 406 shown in FIG. 4. In the transmitter 540, analog video channels Aᵢ(t) are processed by N respective ADCs shown as ADCs 500(1)-500(N) (collectively the ADCs 500), followed by N respective DSPs shown as DSPs 502(1)-502(N) (collectively the DSPs 502) and N respective framers shown as framers 504(1)-504(N) (collectively the framers 504).

The analog video channels have respective bandwidths of approximately 6 MHz each. The ADCs 500 are controlled by N respective ADC clocks shown as ADC clocks 512(1)-512(N) (collectively the ADC clocks 512). In one embodiment, the ADC clocks 512 function independently of each other. Accordingly, the ADC clocks 512 increment N respective transmitter counters shown as transmitter counters 506(1)-506(N) (collectively the transmitter counters 506).

The outputs of the transmitter counters 506 are provided to the respective framers 504 for transmission to the receiver 410. The framers 504 arrange the digitized data corresponding to each analog video channel in a specified order. The framers 504 also add values (i.e., transmitter time stamps) of the respective transmitter counters 506 periodically or intermittently. The outputs of the respective framers 504 are provided to inputs of a multiplexer 510. In one embodiment, the multiplexer 510 uses time division multiplexing to combine the outputs of the framers 504 into one transport stream for transmission to the receiver 410.

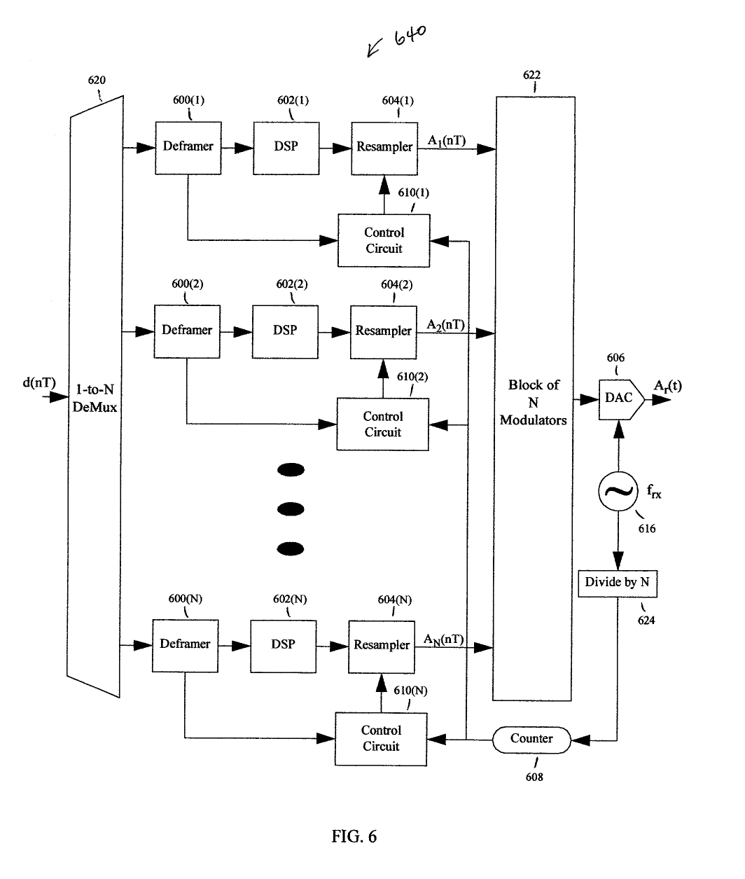

FIG. 6 is a block diagram of a receiver 640, which is one embodiment of the receiver 410 shown in FIG. 4. The receiver 640 can recover multiple analog and/or digital video signals from one transport stream. The receiver 640 includes a demultiplexer 620 which separates the incoming transport stream into individual streams of frames. The individual streams are provided to N respective deframers shown as deframers 600(1)-600(N) (collectively the deframers 600). The deframers 600 extract the respective transmitter time stamps during the deframing process which recovers the digitized data (i.e., payload). The deframers 600 provide the transmitter time stamps to N respective control circuits shown as control circuits 610(1)-610(N) (collectively the control circuits 610).

The deframers 600 provide the recovered digitized data corresponding to each analog video channel to N respective DSPs shown as DSPs 602(1)-602(N) (collectively the DSPs 602). The outputs of the DSPs 602 are provided to N respective resamplers shown as resamplers 604(1)-604(N) (collectively the resamplers 604). The outputs of the resamplers 604 are provided to a modulator block 622 for combination using frequency division multiplexing. The combined digital signal is provided to a DAC 606 for conversion into a broadband analog signal Aᵣ(t) which can be further processed and broadcast to the homes 412.

A DAC clock 616 controls the operation of the DAC 606. In one embodiment, the DAC clock 616 is provided to a divider 624 before being provided to a receiver counter 608. Thus, the receiver counter 608 is being incremented by a clock derived from the DAC clock 616. The output of the receiver counter 608 is provided to each of the control circuits 610. The control circuits 610 output appropriate control words to the respective resamplers 604 using techniques described above.

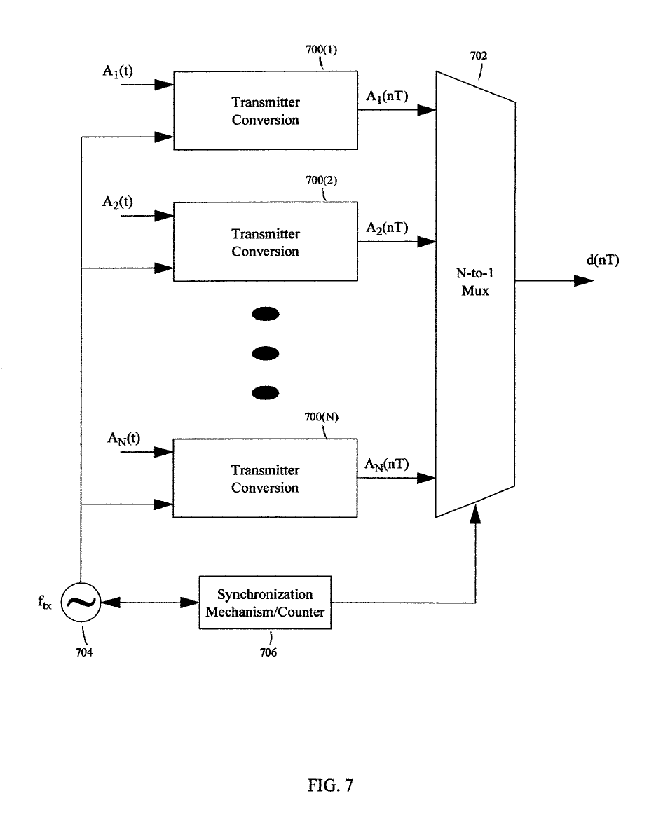

FIG. 7 is a block diagram of a transmitter 740, which is an alternate embodiment of the transmitter 406 shown in FIG. 4. In the transmitter 740, analog video channels Aᵢ(t) are processed by N respective transmitter conversion circuits shown as transmitter conversion circuits 700(1)-700(N) (collectively the transmitter conversion circuits 700). The transmitter conversion circuits 700 are controlled by a common transmitter clock 704. The transmitter clock 704 also controls a transmitter synchronization circuit 706 (e.g., a transmitter counter).

The outputs the transmitter conversion circuits 700 are provided to a multiplexer 702. In one embodiment, the multiplexer 510 uses time division multiplexing to combine the outputs of the transmitter conversion circuits 700 and the output (i.e., transmitter time stamp) from the transmitter synchronization circuit 706 into one transport stream for transmission to the receiver 410.

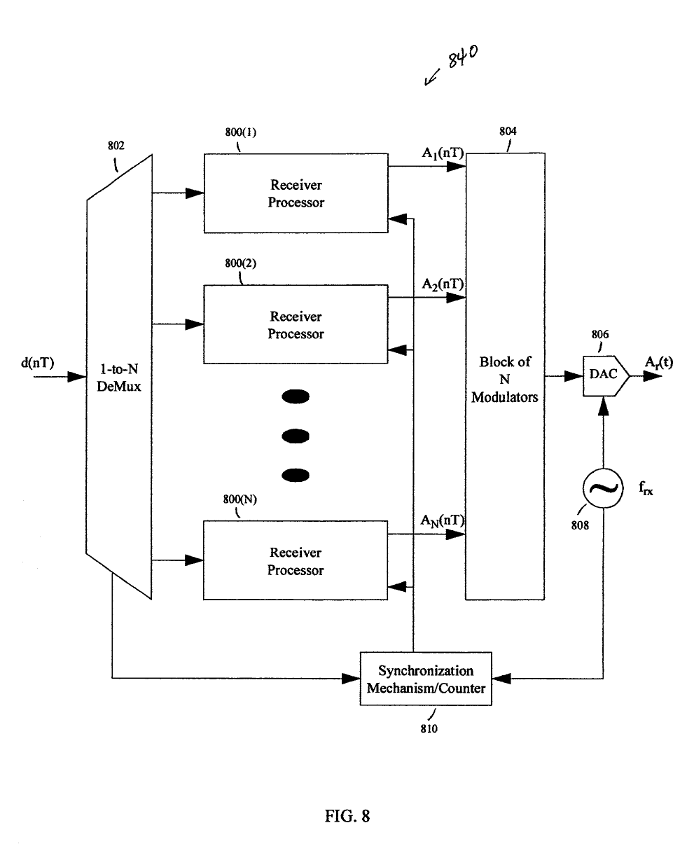

FIG. 8 is a block diagram of a receiver 840, which is an alternate embodiment of the receiver 410 shown in FIG. 4. The receiver 840 includes a demultiplexer 802 which separates the incoming transport stream into individual data streams and extracts the transmitter time stamp. The transmitter time stamp is provided to a receiver synchronization circuit 810. The individual streams are provided to N respective receiver processors shown as receiver processors 800(1)-800(N) (collectively the receiver processors 800). The outputs of the receiver processors 800 are provided to a modulator block 804 for combination using frequency division multiplexing. The combined digital signal is provided to a DAC 806 for conversion into a broadband analog signal Aᵣ(t) which can be further processed and broadcast to the homes 412.

A DAC clock 808 controls the operation of the DAC 806. In one embodiment, the DAC clock 808 is provided to the receiver synchronization circuit 810. For example, the DAC clock 808 (or some multiple thereof) can increment a counter in the receiver synchronization circuit 810. The receiver synchronization circuit 810 outputs an appropriate control signal to the receiver processors 800 using the data rate equalization techniques described above. The receiver processor 800 include respective resampling circuits for adjusting data rates of digitized information.

In the particular embodiments described above, the data rate equalization techniques are applied to a forward path of the cable television distribution system. The data rate equalization techniques can also be used to synchronize the cable reverse path (i.e., upstream network) from the homes 412 to the headend 404.

Although described above in connection with particular embodiments of the present invention, it should be understood that the descriptions of the embodiments are illustrative of the invention and are not intended to be limiting. Various modifications and applications may occur to those skilled in the art without departing from the true spirit and scope of the invention as defined in the appended claims.

What is claimed is:

1. A communication system comprising:
a transmitter comprising:
an analog-to-digital converter;
a first counter; and
a first clock configured to control operation of said analog-to-digital converter and said counter; and
a receiver comprising:
a resampler;
a digital-to-analog converter;
a second counter;
a second clock configured to control operation of said digital-to-analog converter and said second counter; and
a controller configured to receive count data from said first counter and said second counter, to calculate a difference in clock rate between the first clock and the second clock, and to control operation of said resampler based at least in part on said difference in clock rate.

2. The communication system of claim 1, wherein the controller is a frequency offset measurement circuit configured to detect a difference in frequency between the first clock and the second clock.

3. The communication system of claim 1, wherein the controller compares a current value of the first counter with a current value of the second counter to compute a difference in clock rate between the first clock and the second clock.

4. The communication system of claim 1, wherein the controller detects a drift between a rate of change in the first counter and a rate of change in the second counter.

5. The communication system of claim 1 further comprising:
a framer at the transmitter configured to combine the analog-to-digital converter output with the first counter output and to arrange the combination in a specified order for transmission to the receiver; and
a deframer at the receiver configured to separate the analog-to-digital converter output from the first counter output for processing by the receiver.

6. The communication system of claim 1, wherein the controller provides a control word to the resampler for controlling the ratio of input data rate to output data rate.

7. The communication system of claim 1, wherein the first counter is cumulatively incremented by a multiple of the first clock, and the second counter is cumulatively incremented by a multiple of the second clock.

8. A method of synchronizing data rates comprising the acts of:
comparing a first count with a second count, wherein said first count is representative of a first data rate and said second count is representative of a second data rate;
producing a control word for a resampler based on said comparison; and
resampling digital data produced using said first data rate in accordance with said control word.

9. The method of claim 8, wherein the control word is derived from a rate of change in comparison of the first count with the second count.

10. The method of claim 8, wherein the control word is derived from a drift between a rate of change in the first count and a rate of change in the second count.

11. The method of claim 8, wherein the first count is generated by a transmitter and the second count is generated by a receiver.

12. A communication system comprising:
means for producing digitized data at a first data rate;
means for producing a first count that is representative of said first data rate;
means for producing a second count that is representative of a second data rate; and
means for converting said digitized data from said first data rate to said second data rate based on a comparison of said first count and said second count.

13. A transmitter in a digital communication system, said transmitter comprising:
at least one analog-to-digital converter configured to sample and digitized an analog input signal;
a conversion clock coupled to the at least one analog-to-digital converter and configured to control the rate at which digital samples of the analog input signal is generated; and
a synchronization circuit coupled to the conversion clock and configured to provide a time stamp signal indicative of the conversion clock operating frequency.

14. The transmitter of claim 13, wherein the synchronization circuit is a counter, and the counter is cumulatively incremented by the conversion clock.

15. The transmitter of claim 13, wherein the time stamp signal is sent intermittently with the digital samples to a receiver in the digital communication system.

16. A receiver in a digital communication system, said receiver comprising:
a resampler configured to take input data at a first data rate and generate output data at a second data rate;
a digital-to-analog converter configured to converter the output data at the second data rate into an analog signal;
a conversion clock coupled to the digital-to-analog converter and configured to control the digital-to-analog converter to operate at the second data rate; and
a synchronization circuit configured to control the resampler operations by sensing a difference between the first data rate and the second data rate.

17. The receiver of claim 16, wherein the synchronization circuit is a counter that is incremented by a multiple of the conversion clock.

18. The receiver of claim 16, wherein the receiver receives the input data from a transmitter operating at the first data rate.
